(19) United States
(12) Patent Application Publication
(10) Pub. No.: US 2013/0193281 A1
(43) Pub. Date: Aug. 1, 2013

(54) RELEASABLE LOCKING CONNECTOR

(71) Applicant: The Music People, Inc., Berlin, CT (US)

(72) Inventor: James R. Hennessey, West Hartford, CT (US)

(73) Assignee: THE MUSIC PEOPLE, INC., Berlin, CT (US)

(21) Appl. No.: 13/740,542

(22) Filed: Jan. 14, 2013

Related U.S. Application Data
(60) Provisional application No. 61/585,914, filed on Jan. 12, 2012.

(51) Int. Cl. F16B 7/00; F16M 13/00

(52) U.S. Cl. CPC F16B 7/00; F16M 13/00
USPC 248/121; 248/127; 248/205.1; 403/334

(57) ABSTRACT

A connector for an equipment support includes a housing having an interior area defined by a wall. The interior area extends inwardly from an opening on one end thereof. The wall has one or more longitudinal slots extending through the wall. The connector includes one or more engagement pads positioned in the interior area and being radially moveable in the longitudinal slot. The engagement pads have an exterior engagement surface and a tapered interior engagement surface. The connector includes a plunger moveably positioned in the interior area. The plunger defines a tapered exterior surface that tapers radially inward from a first end thereof and terminates at a seating end. The tapered exterior surface slidingly engages the tapered interior engagement surface. The plunger defines an activation portion. The engagement pads move radially in response to a force applied to the activation portion of the plunger.

### CROSS REFERENCE TO RELATED APPLICATION

This application claims the benefit of U.S. provisional application No. 61/585,914, filed Jan. 12, 2012, the contents of which are incorporated herein by reference in their entirety.

### TECHNICAL FIELD

The present invention is directed in general to releasable locking connectors and, more particularly, to a releasable locking connector for use in mounting equipment on a support.

### BACKGROUND

A stand for supporting equipment such as speakers, microphones, lights, and musical equipment such as cymbals and sheet music holders generally has an upper member that extends vertically from a legged base. Typically, the upper member is tubular. The upper member typically includes a male connector positioned on a distal end thereof. The equipment includes a cavity such as a bore extending into the equipment. The bore is defined by an inside surface having an inside diameter. The male connector defines an outside diameter that is sized to be inserted into a variety of bore sizes of the equipment. Thus, some of the male connectors do not fit snuggly in the bores. Since the equipment is subject to vibration and oscillatory forces, the male connector can vibrate and move in the bore. In some instances the male connector can become inadvertently dislodged from the bore allowing the equipment to fall from the stand.

Some connectors include threaded male connectors and bores. However, use of such threaded connectors is cumbersome and time consuming.

### SUMMARY

In one aspect, the present invention resides in a connector for an equipment support, for example an equipment stand or bracket such as a music equipment stand. The connector includes a housing having an interior area defined by a wall. The interior area extends inwardly from an opening on one end thereof. The wall has one or more longitudinal slots extending through the wall. The connector includes one or more engagement pads positioned in the interior area and being radially moveable in the longitudinal slot. The engagement pads have an exterior engagement surface and a tapered interior engagement surface. The connector includes a plunger moveably positioned in the interior area. The plunger defines a tapered exterior surface that tapers radially inward from a first end thereof and terminates at a seating end. The tapered exterior surface slidingly engages the tapered interior engagement surface. The plunger defines an activation portion. The engagement pads move radially in response to a force applied to the activation portion of the plunger.

In another aspect, the present invention resides in an equipment support including a shaft having one end secured to a base and a second end. A connector is positioned on the second end. The connector includes a housing having an interior area defined by a wall. The interior area extends inwardly from on opening on one end thereof. The wall has one or more longitudinal slots extending through the wall. The connector includes one or more engagement pads positioned in the interior area and being radially moveable in the longitudinal slot. The engagement pads have an exterior engagement surface and a tapered interior engagement surface. The connector includes a plunger moveably positioned in the interior area. The plunger defines a tapered exterior surface that tapers radially inward from a first end thereof and terminates at a seating end. The tapered exterior surface slidingly engages the tapered interior engagement surface. The plunger defines an activation portion. The engagement pads move radially in response to a force applied to the activation portion of the plunger.

### BRIEF DESCRIPTION OF THE DRAWINGS

FIG. 1A is a perspective view of a connector for an equipment support of the present invention;

FIG. 1B is a perspective view of the connector of FIG. 1A, with an extension piece positioned thereon;

FIG. 1C is a perspective view of a external portion of the connector of FIG. 1A;

FIG. 1D is a perspective exploded view of internals of the connector of FIG. 1A;

FIG. 1E is a perspective view of one of the engagement pads of the connector of FIG. 1A;

FIG. 2A is an elevation cross sectional view of the connector of FIG. 1A shown in a retracted position taken across line 2A-2A of FIG. 4A;

FIG. 2B is an elevation cross sectional view of the connector of FIG. 1A shown in a locked position taken across line 2B-2B of FIG. 4B;

FIG. 3 is a top cross sectional view of the connector of FIG. 2A taken across line 3-3;

FIG. 4A is a top cross sectional view of the connector of FIG. 2A taken across line 4A-4A;

FIG. 4B is a top cross sectional view of the connector of FIG. 2B taken across line 4B-4B;

FIG. 4C is an elevation cross sectional view of the connector of FIG. 1B;

FIG. 4D is a partial cross sectional view of another embodiment of the connector of the present invention;

FIG. 5 is an elevation cross sectional view of another embodiment of the connector for an equipment support of the present invention;

FIG. 6 perspective view of another embodiment of the connector for an equipment support of the present invention;

FIG. 7 is perspective view of an embodiment of the connector for of FIG. 6 shown with a collar;

FIG. 8 is a perspective view of an equipment support shown with a connector of FIG. 1A integral therewith;

FIG. 9 is a perspective view of an equipment support shown with a connector of FIG. 1B integral therewith;

FIG. 10 is a perspective view of an equipment support shown with a connector of FIG. 7 integral therewith;

FIG. 11 is a perspective view of the connector of FIG. 1 removably secured to an equipment support;

FIG. 12 is a side elevation view of the connector of FIG. 1A installed on a bracket; and

FIG. 13 is a side elevation view of the several of the connectors of FIG. 1A installed in a series and parallel arrangement in a fixture.

### DETAILED DESCRIPTION

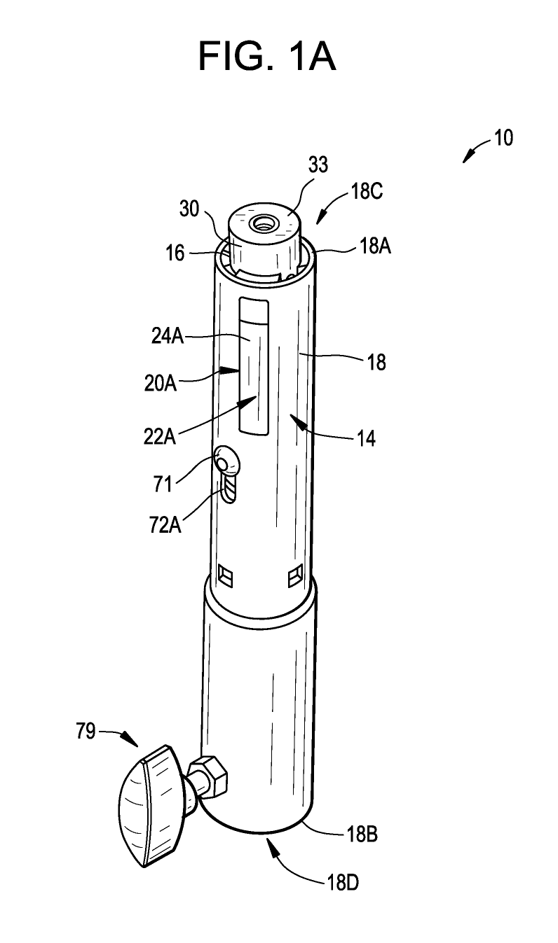

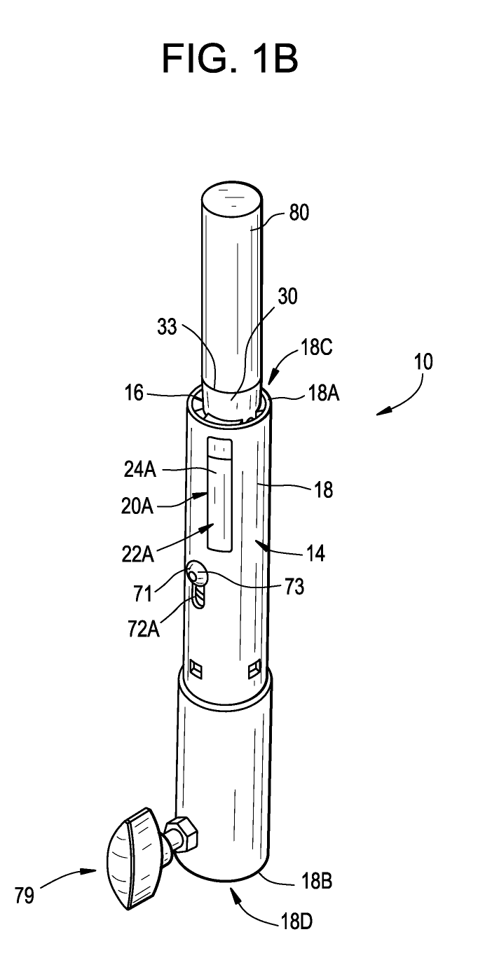

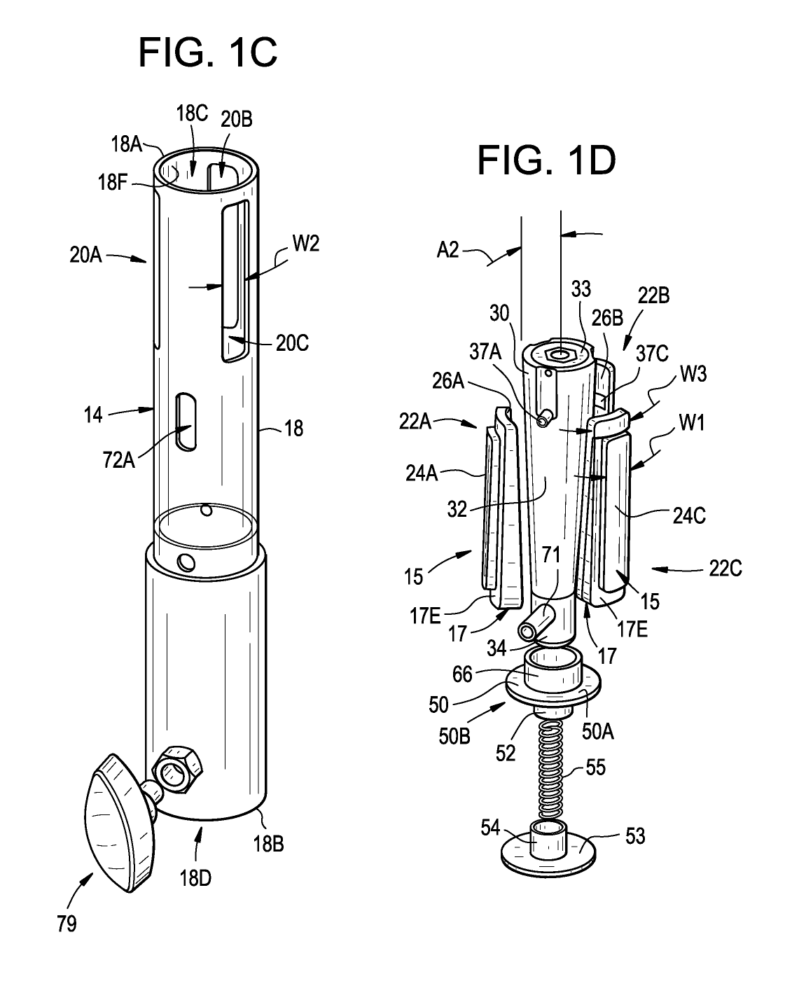

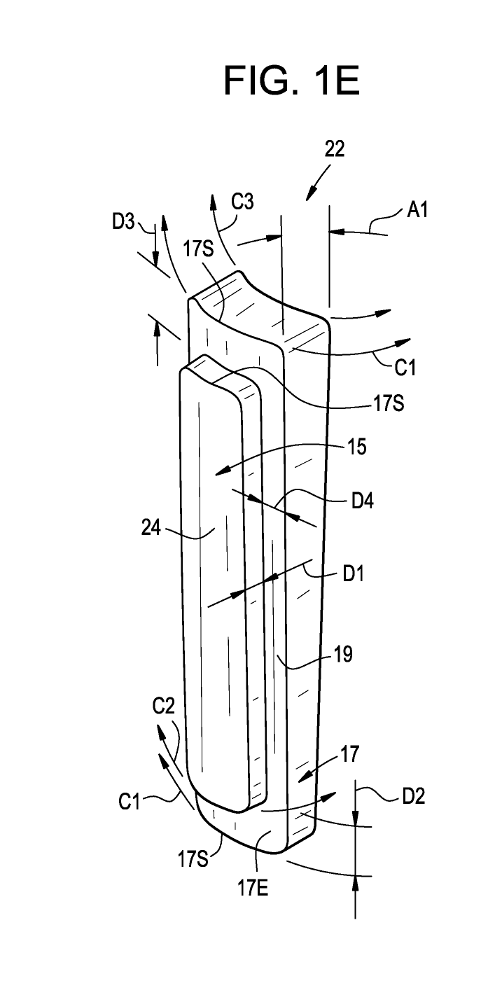

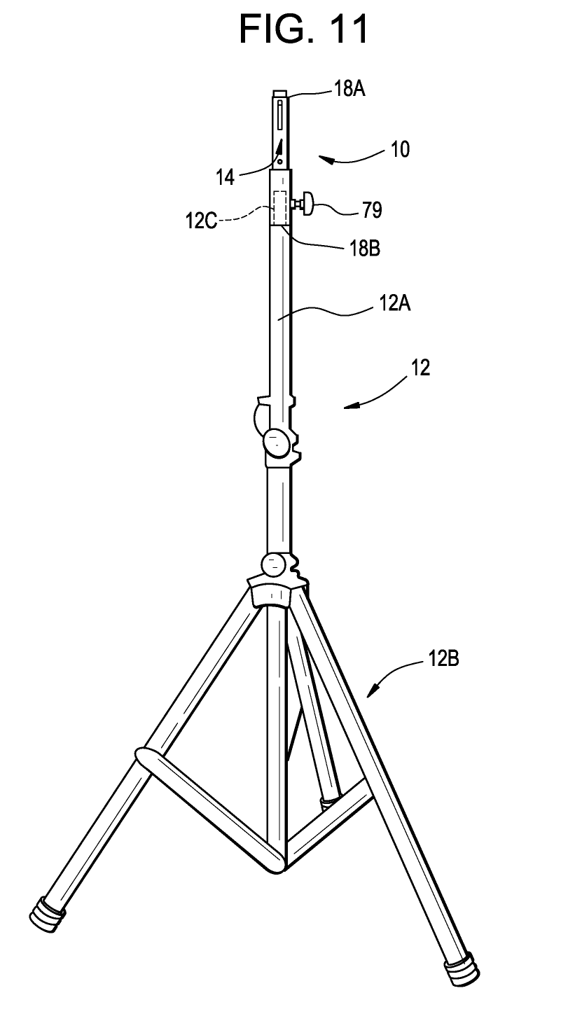

As shown in FIGS. 1A, 2A, 2B and 11 a releasable locking connector 10 for an equipment support 12 (see FIG. 11, for an example of the equipment support, for example an equipment stand) for releasably securing a piece of equipment 42, such as a speaker, musical equipment or the like to the equipment support 12. The equipment support 12 includes a shaft 12A having one end secured to a base 12B. A second end 18B of the connector 10 is removably secured to the shaft 12A. The connector 10 includes a plunger 30 that wedgingly engages engagement pads 22, for example, three engagement pads 22A, 22B and 22C, through longitudinal slots 20A, 20B and 20C, respectively which extend through a wall 18 of a housing 14 defined by the connector 10, as described herein. The plunger 30 is activated by the weight of equipment mounted on the equipment support and the engagement pads 22A, 22B and 22C frictionally and releasably lock inside a bore defined by the equipment, as described herein.

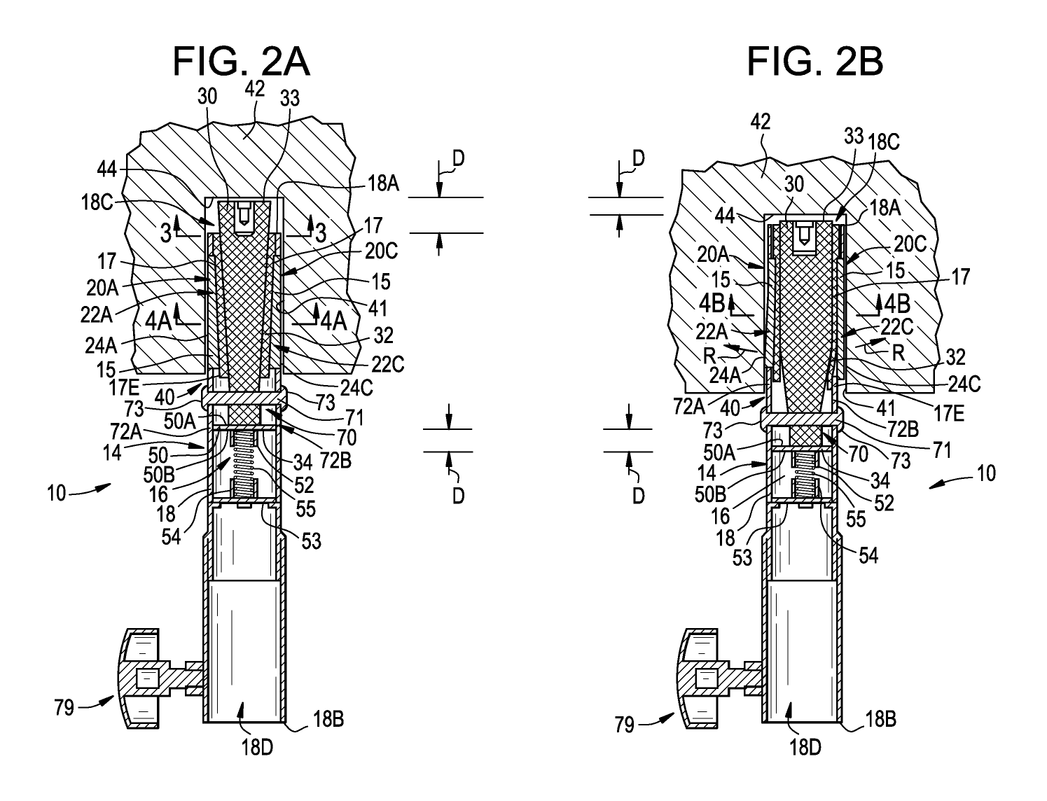

As shown in FIGS. 1A, 2A and 2B, the connector 10 defines a housing 14, for example a generally tubular member. The housing 14 has a cylindrical interior area 16 defined by a wall 18, for example a cylindrical wall. The wall 18 extends between a first end 18A and the second end 18B. The first end 18A has a first opening 18C therein and communicating with the interior area 16 and the second end 18B has a second opening 18D therein communicating with the interior area 16. The interior area 16 extends inwardly from the first opening 18C and the second opening 18D. While the housing 14 is described as having being generally tubular and/or having a cylindrical interior area 16, the present invention is not limited in this regard as the housing 14 and interior area may be of any shape including but not limited to box shaped and oval shaped.

As shown in FIGS. 1A, 2A, 2B, 4A and 4B, a portion of the wall 18 of the housing 14 proximate the first end 18A has three longitudinal slots 20A, 20B and 20C extending there through. While, the wall 18 is shown and described as having three longitudinal slots 20A, 20B and 20C extending there through, the present invention is not limited in this regard as the wall 18 may have any number of slots including more or less than three.

As shown in FIGS. 1A, 1C, 1D, 1E, 2A, 2B, 4A and 4B, the connector 10 has three engagement pads 22, for example, 22A, 22B and 22C positioned in the interior area 16 of the housing 14. As best shown in FIG. 1E, each of the engagement pads 22 has a tab 15 extending outwardly from an exterior surface 17E of a base 17 by a distance D1. The exterior surface 17E of the base 17 is circumferentially curved in the direction shown by the arrow C1 to complementarily fit in the interior area 16 and engage the wall 18 of the housing 14. The tab 15 is spaced apart from peripheral edges 17S of the base 17 by distances D2, D3 and D4, thereby defining a lip 19 extending around the tab 15. As shown in FIG. 1E, the tab 15 defines an exterior engagement surface 24 (also designated 24A, 24B and 24C in the other FIGS.). The engagement pads 22 each have a tapered interior engagement surface 26A, 26B and 26C. As shown in FIGS. 1A, 1E and 2B, each of the tapered interior engagement surfaces 26A, 26B and 26C tapers radially outward so that a portion of each of the engagement pads 22A, 22B and 22C proximate the first end 18A is thinner than that of an opposing end of the engagement pads 22A, 22B and 22C. In one embodiment, the base has a taper of an angle A1. In one embodiment, the angle A1 is about three degrees, plus or minus 0.1 degrees.

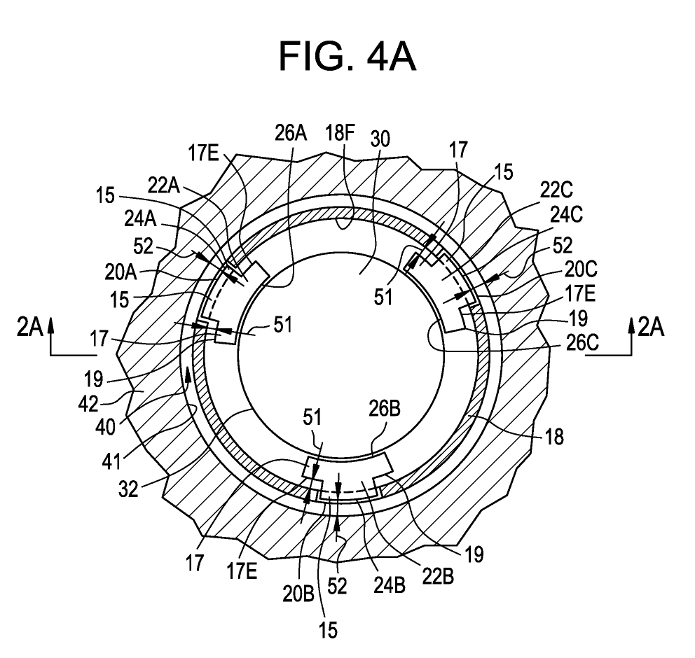

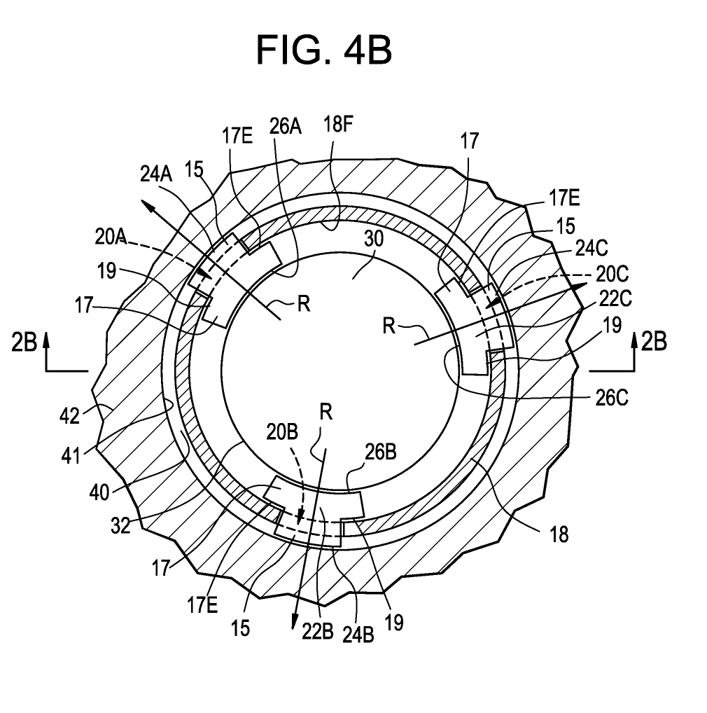

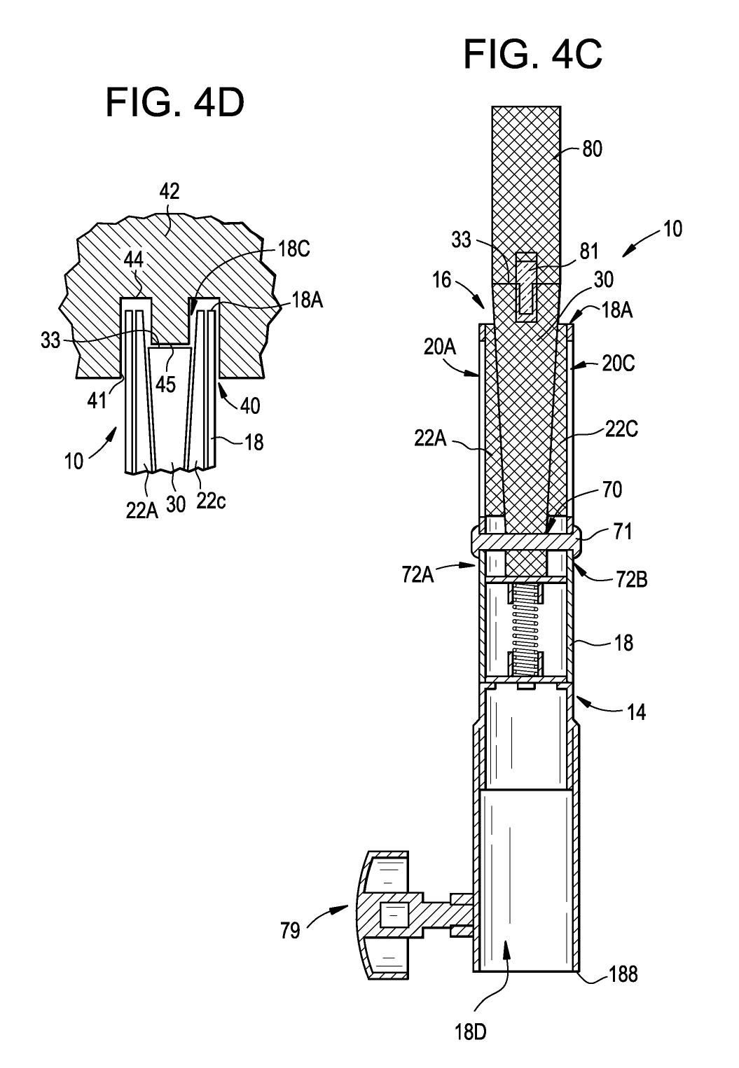

As shown in FIGS. 1A, 1E, 2A, 2B, 4A and 4B, the connector 10 has a plunger 30 that is moveably positioned in the interior area 16 of the housing 14. The plunger 30 has a truncated conical shape that defines a tapered exterior surface 32 that tapers radially inward from a first end 33 of the plunger 30 and terminating at a seating end 34 of the plunger 30. In one embodiment the plunger 30 has a taper defined by an angle A2. In one embodiment, the angle A2 is about 3.2 degrees, plus or minus 0.1 degree. While the angel A1 is described as being about three degrees and the angle A2 is described as being about 3.2 degrees, the present invention is not limited in this regard as any angles of combinations of angles may be employed including but not limited to A1 and A2 differing by 0.1, 0.2, 0.3, 0.4, 0.5 or 0.6 degrees or differing by more than 0.6 degrees or less than 0.1 degrees. The tapered exterior surface 32 is complementary in shape to and slidingly or wedgingly engages the tapered interior engagement surfaces 26A, 26B and 26C of the engagement pads 22A, 22B and 22C. In the embodiment shown in FIGS. 1A, 2A, 2B, 4A and 4B, the first end 33 of the plunger 30 extends out of the first opening 18C of the housing 14. The first end 33 defines an activation portion that receives a force which causes the plunger 30 to move into the housing 14 by a distance D. Movement of the plunger 30 into the housing 14 causes the engagement pads 22A, 22B and 22C to extend radially outward through the respective one of the longitudinal slots 20A, 20B and 20C in the direction indicated by arrows marked R. As a result, the exterior engagement surface 24A, 24B and 24C frictionally engage and releasably lock inside a piece of equipment 42 as described herein. As illustrated in the embodiment in FIGS. 2A, 2B, 4A and 4B, a portion of the connector 10 proximate the first end 18A is positioned in a bore 40 defined by an interior surface 41 of a piece of equipment 42. An abutment surface 44 inside the bore 40 engages the first end 33 of the plunger 30, as described further herein.

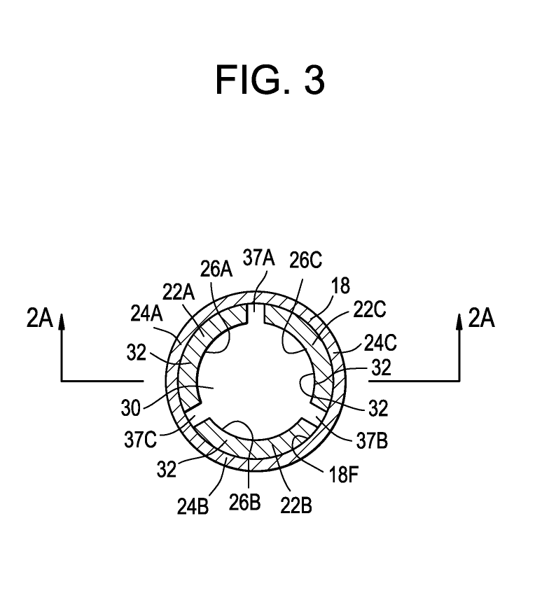

In the embodiment shown in FIG. 3, the plunger 30 has three guides, for example pins 37A, 37B and 37C, extending radially from the tapered exterior surface 32. An exterior portion of the pins 37A, 37B and 37C are positioned between adjacent pairs of the engagement pads 22A, 22B and 22C. The pins 37A, 37B and 37C slidingly engage an interior surface 18F defined by the wall 18 and center the plunger 30 in the housing 14. While the guides are described as being pins 37A, 37B and 37C, the present invention is not limited in this regard as the other guides may be employed including but not limited to ribs.

While the first end 33 is shown and described as extending out of the first opening 18C, the present invention is not limited in this regard as the first end 33 may be recessed in the first opening 18C and may engage a protrusion 45 extending from the abutment surface 44 and into the first opening 18C, as shown in FIG. 4D.

Referring to FIGS. 1B and 2C, an extension piece 80 is removably secured to the first end 33 of the plunger 30. The extension piece 80 allows use of the connector 10 with equipment 42 having deep bores 40.

Referring to FIGS. 1C, 1D, 2A and 2B, the connector 10 includes a bearing plate 50 positioned in the interior area 16 and slidingly engaging an inner surface 18F of the wall 18. One side 50A of the bearing plate 50 engages the seating end 34 of the plunger 30. In one embodiment, the side 50A of the bearing plate 50 has a cup 66 secured thereon for receiving the seating end 34 of the plunger 30. The other side 50B of the bearing plate 50 has a first socket 52 extending therefrom. A support 53 is positioned in the interior area 16 and secured to the inner surface of the wall 18. The support 53 has a second socket 54 secured thereto. The first socket 52 and the second socket 54 are aligned with, spaced apart from and face one another. An actuator, such as a spring 55, is positioned in the first socket 52 and the second socket 54. The actuator (e.g., the spring 55) urges the bearing plate 50 and the first end 33 of the plunger away from the support 53. The spring 55 has a predetermined spring rate selected to urge and move the plunger 30 to a retracted position as shown in FIGS. 2A and 4A and described further herein. The spring rate is also selected to allow the plunger 30 to move to the locked position as shown in FIGS. 2B and 4B upon application of a force to the activation portion defined by the first end 33 of the plunger 30. In one embodiment, the force is about equal to the weight of the equipment.

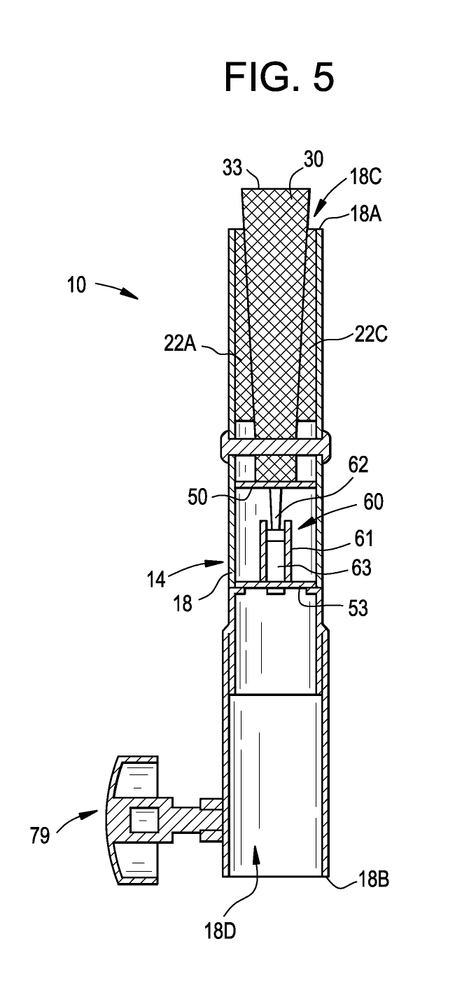

While the actuator is shown and described as being the spring 55, the present invention is not limited in this regard as other actuators may be employed including but not limited to a piston and cylinder actuator 60 having a cylinder 61 with a piston 62 positioned therein as shown in FIG. 5. The piston 62 seals a compressible fluid, such as air 63 within the cylinder 61. The piston and cylinder actuator 60 is mounted between the support 53 and the bearing plate 50 and urges the bearing plate 50 and the plunger 30 away from the support 53, similar to that described above for the spring 55.

As shown in FIGS. 2A and 2B, a bore 70 radially extends through the plunger 30 proximate the seating end 34. As shown in FIGS. 1A, 2A and 2B the housing 14 includes second longitudinal slots 72A and 72B extending axially along and through opposing sides of the wall 18. The second longitudinal slots 72A and 72B are aligned with the bore 70. A pin 71 extends through and slidingly engages the second longitudinal slots 72A and 72B. The pin 71 extends through the bore 70. Axial movement of the pin 71 is guided by the second longitudinal slots 72A and 72B and opposing axial ends of the second longitudinal slots 72A and 72B limit axial movement of the pin 71 in the second longitudinal slots 72A and 72B to the distance D. Thus axial movement of the plunger 30 is limited by the limited movement of the pin 71 in the second longitudinal slots 72A and 72B to the distance D. The pin 71 is restrained from becoming axially dislodged from the slots 72A and 72B by a head 73 formed on or secured to opposing ends of the pin 71.

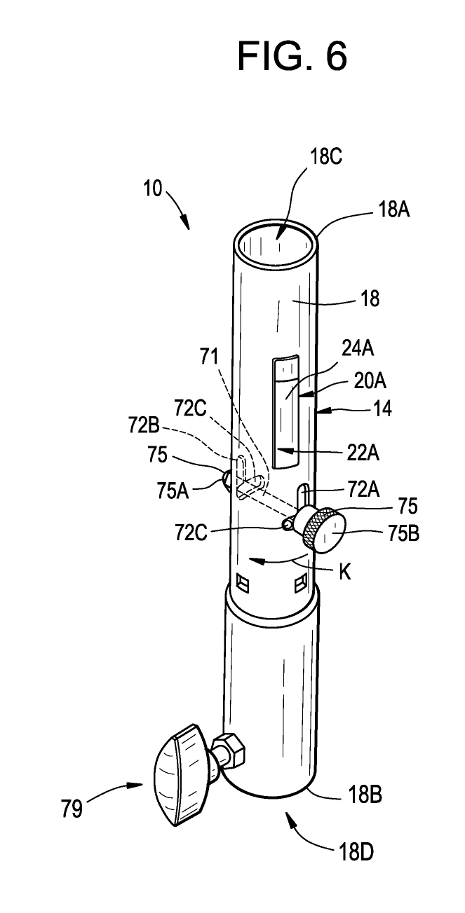

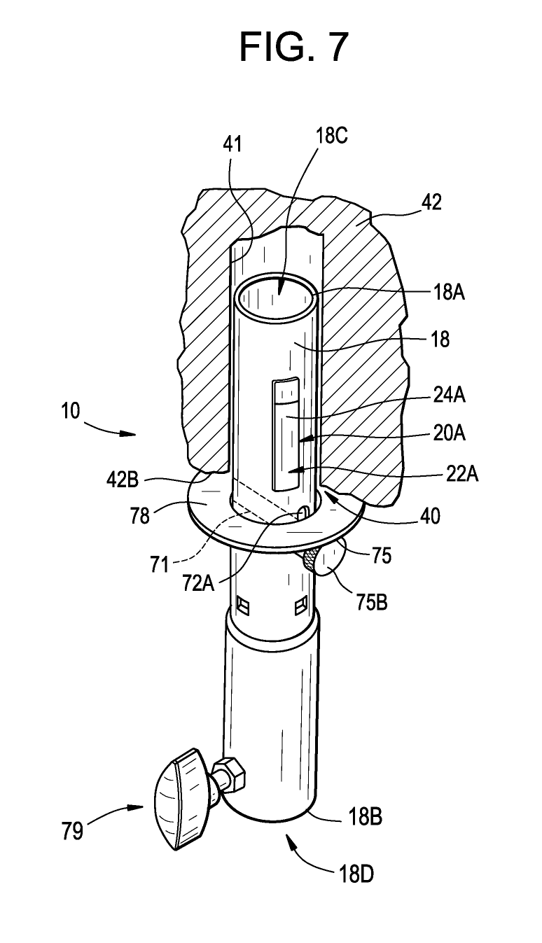

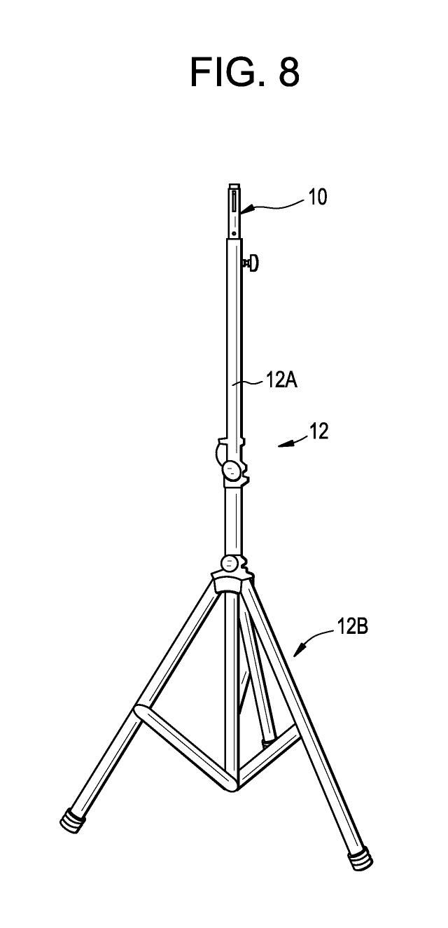

Referring to FIG. 6, the pin 71 extends radially outward from the wall 18 of the housing 14 and defines an actuation surface 75 on opposing ends 75A and 75B of the pin 71. Thus in the embodiment shown in FIG. 6, the actuation portion of the plunger 30 includes the actuation surface 75 of the pin 71. In the embodiment shown in FIG. 7, a collar, for example a washer 78 is positioned around the housing 14 and is disposed on the actuation surfaces 75 of the ends 75A and 75B of the pin 71. The first end 18A of the connector 10 is positioned in the bore 40 of the piece of equipment 42 with an outer surface 42B of the piece of equipment 42 engaging the washer 78.

Referring to FIG. 6, in one embodiment, each of the second longitudinal slots 72A and 72B include a circumferential extension slot 75C extending therefrom, for example forming an L-shaped slot. The L-shaped slot and the circumferential extension slot 75C are a detent mechanism having utility in locking the plunger from axial movement when the pin 71 is rotated into the circumferential extension slot 75C, for example in the direction indicated by the arrow K.

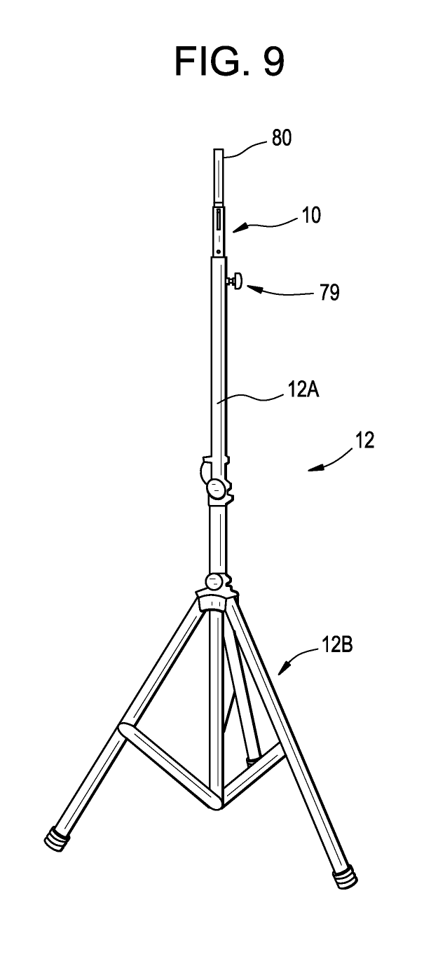

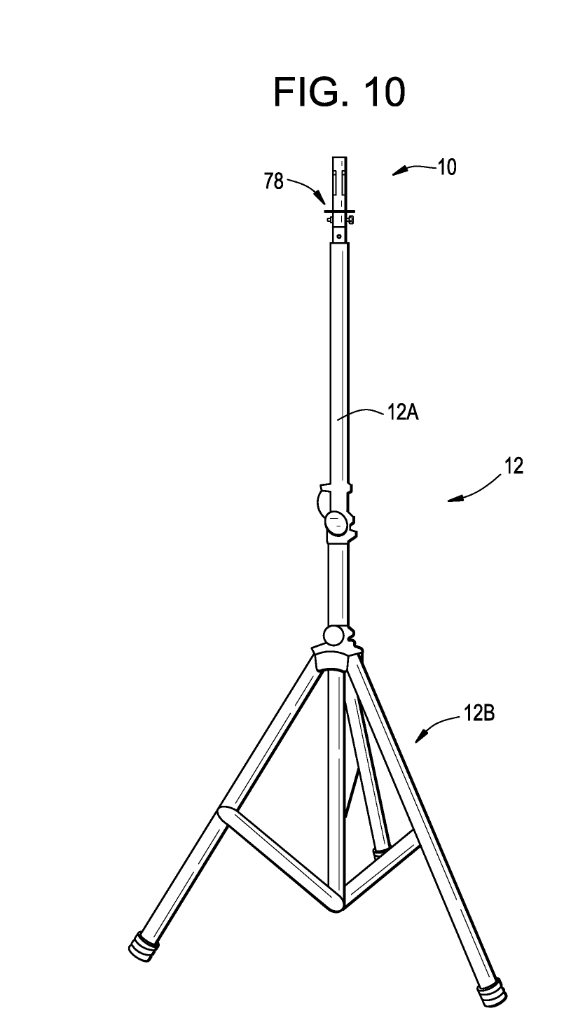

The connectors 10 of FIGS. 1A, 1B, 2A, 2B, 2C, 5, 6, 7 and 11 are shown having a second opening 18D proximate the second end 18B of the housing 14. The second opening 18D is configured to receive a male portion 12C formed on the shaft 12A of the equipment support 12 (as shown in FIG. 11). The connector 10 includes a fastener assembly 79 for securing the connector 10 to the equipment support 12. While the connector 10 is shown in FIGS. 1A, 1B, 2A, 2B, 2C, 5, 6, 7 and 11 as being separable from the equipment support 12, the present invention is not limited in this regard as the connector 10, for example the housing 14 may be integrally formed with the equipment support 12 as shown in FIGS. 8-10.

Referring to FIGS. 2A and 4A, the connector 10 is shown in a retracted position with the first end 18A of the housing 14 inserted into the bore 40 of the piece of equipment 42 which is supported, for example by a person. In the retracted position the exterior surface 17E of the base 17 is spaced apart from the interior surface 18F of the wall 18, by a distance S1. The first end 33 of the plunger 30 initially engages the abutment surface 44 in the bore 40. In the retracted position the plunger 30 is urged away from the support 53 by the actuator, for example the spring 55. In the retracted position, the engagement pads 22A, 22B and 22C spaced away from the interior surface 18F of the wall 18, for example, are recessed in the slots 20A, 20B and 20C. In one embodiment, in the retracted position, the exterior surfaces 24A, 24B and 24C of the engagement pads 22A, 22B and 22C, respectively are flush with the exterior surface of the wall. In the retracted position, the exterior surfaces 24A, 24B and 24C of the engagement pads 22A, 22B and 22C are spaced apart from the interior surface 41 of the bore 40, by a distance S2.

Referring to FIGS. 2A, 2B, 4A and 4B, each of the tabs 15 of the engagement pads 22A, 22B and 22C is aligned with and is sized to moveably extend through a respective one of the longitudinal slots 20A, 20B and 20C, as described herein. The lip 19 is larger than each of the longitudinal slots 20A, 20B and 20C and therefore prevents the engagement pads 22A, 22B and 22C from dislodging from the housing 14. The lip 19 limits radial movement of the engagement pads 22A, 22B and 22C by abutting the interior surface 18F of the wall 18 of the housing.

Referring to FIGS. 2B and 4B, the connector is shown in the retracted position wherein the plunger 30 moves towards the support 53. When the piece of equipment 42 is released or the connector 10 is further forced into the bore 40 the first end 33 of the plunger 30 moves as much as the distance D into the housing 14 towards the support 53 and thereby compresses the spring 55 as much as the distance D. The tapered exterior surface 32 of the plunger 30 slidingly engage the tapered interior engagement surface 26A, 26B and 26C of the engagement pads 22A, 22B and 22C and via a wedging action, forcing the engagement pads 22A, 22B and 22C to move radially outward in the direction indicated by the arrows R, into a locked position as shown in FIGS. 2B and 4B. In the locked position, the exterior engagement surface 24A, 24B and 24C of the engagement pads 22A, 22B and 22C frictional engage the interior surface 41 of the bore 40 thereby releasably locking the connector in the bore 40. In the locked position, the exterior surface 17E of the base 17, i.e., the lip 19 engages the interior surface 18F of the wall thereby preventing the engagement pads 22A, 22B and 22C from becoming dislodged from the housing 14. When the piece of equipment 42 is urged away from the connector 10, the spring 55 urges the plunger 30 away from the support 53 thereby releasing the engagement pads 22A, 22B and 22C for the friction engagement with the interior surface 41 of the bore 40.

The connectors 10 of FIGS. 6 and 7 releasably lock the connector 10 in the bore 40 of the piece of equipment 42, similar to that shown and described for the connector 10 of FIGS. 2A, 2B, 4A and 4B, except that the plunger 30 is moved toward the support 53 by a force applied to the engagement surface 75 of the pin 71 (FIG. 6) or to the engagement surface 75 of the pin 71 and the washer 78, by the outer surface 42B of the piece of equipment 42.

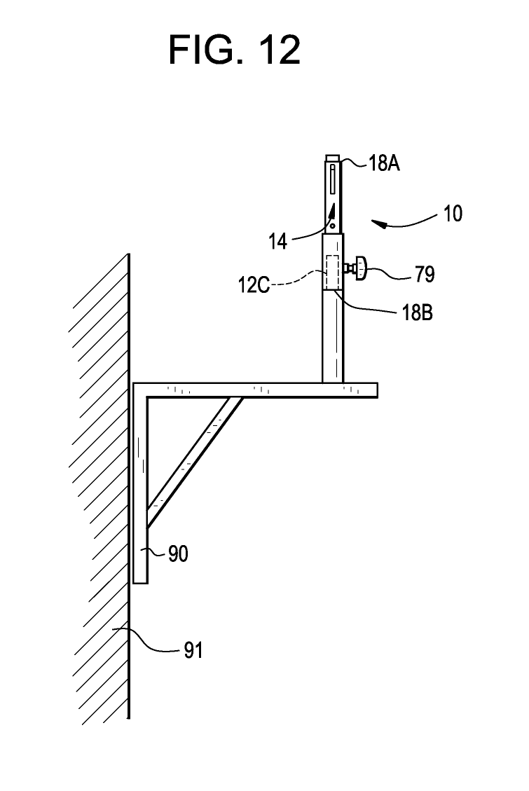

Referring to FIG. 12, the connector 10 is shown positioned on an equipment support, for example a bracket 90 secured to a structure, for example a wall 91. While the connector 10 is shown and described in FIG. 12 as being positioned on the bracket 90 secured to the wall 91, the present invention is not limited in this regard as the connector 10 may be positioned, either fixedly or removably to other mounting members such as but not limited to posts, pegs, blocks or the like secured to any surface or structure including but not limited to a ceiling, exercise equipment, musical equipment or the like.

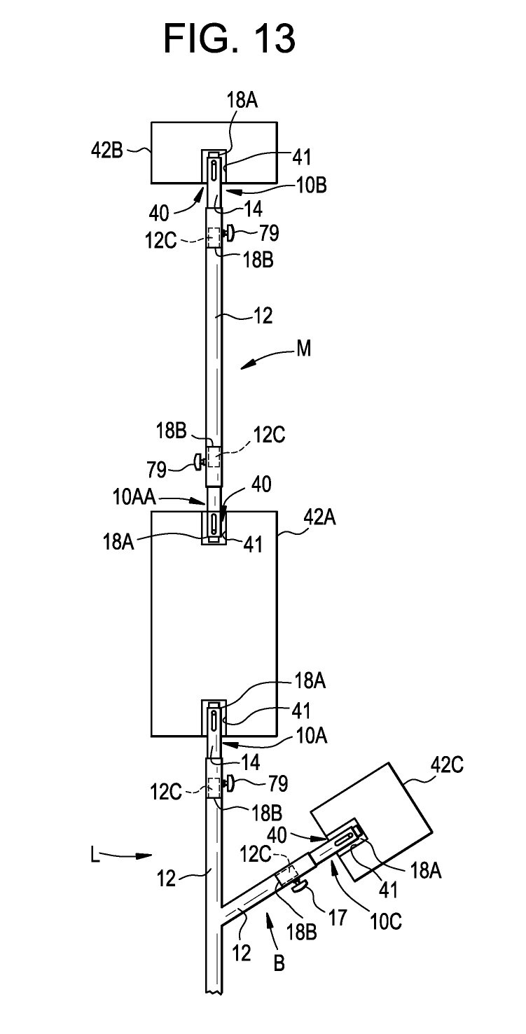

Referring to FIG. 13, a plurality of the connectors 10, for example four connectors 10A, 10AA, 10B and 10C are shown, are used to removably secure multiple pieces of equipment 42 (e.g., three pieces of equipment 42A, 42B and 42C, such as but not limited to speakers) to one another in a series and/or parallel arrangement. In particular, the second end 18B of the connector 10A is positioned on a lower portion L of the equipment support 12 with the first end 18A of the connector 10A disposed in the bore 40 located on an underside of the piece of equipment 42A. The first end 18A of the connector 10AA is disposed in another bore 40 located on an opposing side of the piece of equipment 42A. The second end 18B of the connector 10AA is positioned in one end of an intermediate portion M of the equipment support 12. An opposing end of the intermediate portion M of the equipment support 12 has the second end 18B of the connector 10B positioned therein. The first end 18A of the connector 10B is disposed in the bore 40 of another piece of equipment 42B. In one embodiment, the equipment support 12 includes a branch connection B extending therefrom. The branch portion B of the equipment support 12 has the second end 18B of the connector 10C positioned therein. The first end 18A of the connector 10C is positioned in the bore 40 of yet another piece of equipment 42C. While the connectors 10A, 10AA, 10B and 10C are shown and described in the series and parallel arrangement in the equipment support 12, the present invention is not limited in this regard as any number of connectors may be positioned in any combination of stands, brackets, supports, mounting members and/or pieces of equipment.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the foregoing description.

What is claimed is:

1. A connector for an equipment support comprising:
a housing having an interior area defined by a wall, the interior area extending inwardly from an opening on one end thereof, the wall having at least one first longitudinal slot extending through the wall;
at least one engagement pad positioned in the interior area and being radially moveable in the at least one first longitudinal slot, the at least one engagement pad having an exterior engagement surface and a tapered interior engagement surface; and
a plunger moveably positioned in the interior area, the plunger defining a tapered exterior surface that tapers radially inward from a first end thereof and terminating at a seating end, the tapered exterior surface slidingly engaging the tapered interior engagement surface, and the plunger defining an activation portion;
wherein the at least one engagement pads move radially in response to a force applied to the activation portion of the plunger.

2. The connector of claim 1, wherein the activation portion is positioned on the first end of the plunger.

3. The connector of claim 2, wherein the activation portion extends from the opening.

4. The connector of claim 2, wherein an extension piece is removably secured to the activation portion.

5. The connector of claim 4, wherein the extension piece is positioned outside of the opening.

6. The connector of claim 2, wherein the activation portion is recessed in the opening.

7. The connector of claim 1, further comprising:
a bore radially extending through the plunger;
at least one second longitudinal slot extending through the wall; and
a pin moveably positioned in the at least one second longitudinal slot and extending through the bore,
wherein axial movement of the pin in the at least one second slot is limited by opposing axial ends of the at least one second slot.

8. The connector of claim 1, further comprising:
a support member positioned in the interior area of the housing and secured to the wall of the housing; and
an actuator extending between the support member and the seating end of the plunger, wherein the actuator urges the plunger away from the support member when the force is removed from the activation portion of the plunger.

9. The connector of claim 1, wherein the actuator is one of a spring or a piston and cylinder assembly.

10. The connector of claim 1, further comprising a fastener positioned on the housing for removably securing the housing to an equipment support.

11. The connector of claim 1, wherein the plunger has at least one guide radially extending from the tapered exterior surface between adjacent ones of the at least one engagement pad and slidingly engaging an interior surface defined by the wall.

12. The connector of claim 11, wherein the at least one guide causes the plunger to be centered in the housing.

13. The connector of claim 11 wherein the at least one guide is at least one of a rib and a pin.

14. The connector of claim 7, wherein actuation portion further comprises the pin and wherein the pin extends radially outward from the housing and defines an actuation surface thereon.

15. The connector of claim 14, wherein the actuation portion further comprises a collar movably positioned around the housing and engaging the actuation surface of the pin.

16. The connector of claim 7 wherein the at least one second longitudinal slot has a circumferential extension portion.

17. The connector of claim 16 wherein the at least one second longitudinal slot and the circumferential extension portion define an L-shape detent mechanism.

18. The connector of claim 1, wherein the housing is integral with the equipment support.

19. An equipment support comprising:
at least one shaft having one end secured to a base, and the shaft having a second end; and
at least one connector positioned on the second end, the connector comprising:
a housing having an interior area defined by a wall, the interior area extending from an opening on one end thereof, the wall having at least one first longitudinal slot extending through the wall;
at least one engagement pad positioned in the interior area and being radially moveable in the at least one first longitudinal slot, the at least one engagement pad having an exterior engagement surface and a tapered interior engagement surface; and
a plunger moveably positioned in the interior area and defining first end, the plunger defining a tapered exterior surface that tapers radially inward from the first end and terminating at a seating end, the tapered exterior surface slidingly engaging the tapered interior engagement surface, and the plunger defining an activation portion thereon, wherein the at least one engagement pads move radially in response to a force applied to the activation portion of the plunger.

20. The equipment support of claim 19, wherein the equipment support is a stand.

21. The equipment support of claim 19, wherein the equipment support is a bracket.

22. The equipment support of claim 19, wherein a plurality of pieces of equipment are removably secured to the at least one connector.
